(19) United States
(12) Patent Application Publication
(10) Pub. No.: US 2016/0230957 A1
(43) Pub. Date: Aug. 11, 2016

(54) REMOTE ILLUMINATION SYSTEM

(71) Applicant: 3M INNOVATIVE PROPERTIES COMPANY, Saint Paul, MN (US)

(72) Inventors: Vadim N. Savvateev, Saint Paul, MN (US); William F. Edmonds, Minneapolis, MN (US); Olester Benson, Jr., Woodbury, MN (US); Michael A. Meis, Stillwater, MN (US); Anthony J. Piekarczyk, Inver Grove Heights, MN (US); Qingbing Wang, Woodbury, MN (US)

(21) Appl. No.: 15/026,838

(22) PCT Filed: Oct. 1, 2014
(86) PCT No.: PCT/US2014/058586

§ 371 Date: Apr. 1, 2016

Related U.S. Application Data
(60) Provisional application No. 61/886,165, filed on Oct. 3, 2013.

(51) Int. Cl. F21V 7/00; F21V 7/22; F21V 7/04

(52) U.S. Cl. CPC F21V 7/0091; F21V 7/0008; F21V 7/0033; F21V 7/0066; F21V 7/043; F21V 7/048; F21V 7/22

(57) ABSTRACT

The present disclosure describes light delivery and distribution components of a ducted lighting system having a cross-section that includes at least one curved portion and a remote light source. The delivery and distribution system (i.e., light duct and light duct extractor) can function effectively with any light source that is capable of delivering light which is substantially collimated about the longitudinal axis of the light duct, and which is also preferably substantially uniform over the inlet of the light duct.

### BACKGROUND

The transport of visible light can use mirror-lined ducts, or smaller solid fibers which exploit total internal reflection. Mirror-lined ducts include advantages of large cross-sectional area and large numerical aperture (enabling larger fluxes with less concentration), a robust and clear propagation medium (i.e., air) that leads to both lower attenuation and longer lifetimes, and a potentially lower weight per unit of light flux transported.

In some applications, physical placement of a light source within an enclosure can become unfavorable, for example when the enclosure contains an environment that is temperature sensitive or includes flammable or explosive materials that must be protected from electrical sources and heat generating bodies. Mirror-lined ducts can enable the transport of remotely generated light to the interior environment.

### SUMMARY

The present disclosure describes light delivery and distribution components of a ducted lighting system having a cross-section that includes at least one curved portion, and a remote light source. The delivery and distribution system (i.e., light duct and light duct extractor) can function effectively with any light source that is capable of delivering light which is substantially collimated about the longitudinal axis of the light duct, and which is also substantially uniform over the inlet of the light duct. In one aspect, the present disclosure provides a lighting element that includes a hollow light duct having a longitudinal axis, opposing first and second ends, a light output region, and a curved cross-section. An interior surface of the hollow light duct includes a light transmissive region adjacent the light output region, the light transmissive region subtending an output angle perpendicular to the longitudinal axis from a first position proximate the first end to a second position proximate the second end. The lighting element further includes a turning film disposed adjacent the light output region, the turning film having a turning surface that includes tapered protrusions, each having a vertex adjacent the interior of the hollow light duct, wherein light rays propagating through the hollow light duct that intersect the light transmissive region, exit the hollow light duct and are redirected by the turning film to a direction substantially normal to the longitudinal axis.

In another aspect, the present disclosure provides an enclosure that includes an interior space and a lighting element disposed in the interior space. The lighting element includes a hollow light duct having a longitudinal axis, opposing first and second ends, a light output region, and a curved cross-section. An interior surface of the hollow light duct includes a light transmissive region adjacent the light output region, the light transmissive region subtending an output angle perpendicular to the longitudinal axis that changes from a first position proximate the first end to a second position proximate the second end. The lighting element further includes a turning film disposed adjacent the light output region, the turning film having a turning surface that includes tapered protrusions, each having a vertex adjacent the interior surface of the hollow light duct. The enclosure further includes a first light source disposed exterior to the interior space and adjacent the first end, capable of injecting a first light into the hollow light duct within a first collimation half-angle of the longitudinal axis, wherein light rays propagating through the hollow light duct that intersect the light transmissive region, exit the hollow light duct and are redirected by the turning film to a direction substantially normal to the longitudinal axis.

In yet another aspect, the present disclosure provides a refrigerated enclosure that includes an interior space; a visible light transparent viewing port; and a lighting element disposed in the interior space, the lighting element including a hollow light duct having a longitudinal axis, opposing first and second ends, a light output region, and a curved cross-section. An interior surface of the hollow light duct includes a light transmissive region adjacent the light output region, the light transmissive region subtending an output angle perpendicular to the longitudinal axis that changes from a first position proximate the first end to a second position proximate the second end. The lighting element further includes a turning film disposed adjacent the light output region, the turning film having a turning surface that includes tapered protrusions, each having a vertex adjacent the interior surface of the hollow light duct. The refrigerated enclosure further includes a first light source disposed exterior to the interior space and adjacent the first end, capable of injecting a first light into the hollow light duct within a first collimation half-angle of the longitudinal axis, wherein light rays propagating through the hollow light duct that intersect the light transmissive region, exit the hollow light duct and are redirected by the turning film to a direction substantially normal to the longitudinal axis.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIGS. 1A-1C shows perspective schematic views of a lighting element;

FIG. 2A shows an exploded perspective schematic view of a lighting element;

FIG. 2B shows a perspective schematic view of a lighting element;

FIG. 2C shows a perspective schematic of a turning film;

FIG. 2D shows a cross-sectional schematic view of a conical shaped microstructure through the vertex;

FIG. 2E shows a cross-sectional slice through section 2E in FIG. 2D;

FIG. 2F shows a cross-sectional slice through section 2F in FIG. 2D;

FIGS. 3A-3D shows cross-sectional schematic embodiments of lighting elements;

FIG. 4A shows a schematic cross-sectional longitudinal view of a remote illumination light duct;

FIGS. 4B-4D shows schematic views through different cross-sections of FIG. 4A;

FIG. 5 shows a cross-sectional schematic embodiment of a lighting element; and

FIG. 6 shows a perspective schematic view of an enclosure.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Placing a source of light inside or close to an illuminated space or surface may be undesirable for a number of reasons including, for example: adverse effects on light source and/or personnel servicing the source as in heated spaces, radioactivity, noise, damp/humid spaces, solvent vapor; weather factors including solar, wind, dust, temperature extremes, corrosion, and salt; biological factors such as vermin, bugs, pollen, and vegetation; human behaviors such as prisons, psychiatric wards, vandalism in public spaces and in transportation (stadiums, transportation, schools, streets). In some cases, access control including undesirable access of personnel servicing/replacing light source into the illuminated space can have an influence, for reasons such as cleanliness in surgical wards, industrial clean rooms, food preparation, Good Manufacturing Practice, and Good Laboratory Practice; bio-safety related factors; safety and security limited access; regulatory limited spaces; height restricted areas; and cost-limited access including time saved by keeping a source in easily and quickly accessible place. In some cases, there can be physical factors associated with light source itself including, for example, heat associated with light emission undesirable in chilled or cooled spaces; on-sterile source or clean spaces; noise/airflow from fans/spills of cooling liquids, and the like. Separation of a light source from the illuminated spaces may be achieved by placing a physical barrier, by distance, or by a combination of the two.

The present disclosure describes light delivery and distribution components of a ducted lighting system having a cross-section that includes at least one curved portion, and a light source. The delivery and distribution system (i.e., light duct and light duct extractor) can function effectively with any light source that is capable of delivering light which is substantially collimated about the longitudinal axis of the light duct, and which is also substantially uniform over the inlet of the light duct. Similar delivery and distributions systems have been described in, for example, U.S. Patent Application Ser. No. 61/810,294 entitled REMOTE ILLUMINATION LIGHT DUCT (Attorney Docket No. 72398US002), filed on Apr. 10, 2013.

Improvements in the uniformity of the color and/or intensity of the light emitted from the ducted lighting system result from the use of a turning film comprising tapered protrusions, including such films as described, for example, in PCT Patent Application Publication WO2013/101553. In one particular embodiment, the tapered protrusions can be conical shaped microstructures. The tapered protrusions can perform the combined turning and steering of light previously accomplished by the use of two different linear grooved films, described previously. The tapered protrusions generally have a cross-sectional area that decreases from the base of the turning film to form a vertex at the furthest distance from the base of the turning film. The tapered protrusions can have any desired cross-sectional shape, including planar faceted shapes such as both regular and irregularly shaped triangles, rectangles, pentagons, etc,; or curved shapes including both regular and irregularly shaped circles, ovals, ellipses, and the like. In one particular embodiment, a conical shaped microstructured turning film can redirect light extracted from the light duct into a wider range of angles than with prior turning films, enabling improved light distribution and quality in the illuminated space. It is to be understood that any of the tapered protrusions described herein can be used on the turning film; however, in what follows only conical shaped microstructures will be described, without intending to be in any way limiting of the scope of the invention.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

In one aspect, the present disclosure provides a light transport element, and a lighting element that include a light duct having a longitudinal axis, a light duct cross-section perpendicular to the longitudinal axis, a reflective interior surface defining a cavity, and an exterior surface. The lighting element further includes a void disposed the reflective interior surface defining a light output surface, whereby light can exit the cavity; and a turning film disposed adjacent to the light output surface and exterior to the cavity, the turning film having tapered protrusions, such as conical shaped microstructures, each of the tapered protrusions having a vertex adjacent the light output surface of the light duct.

The void in the reflective interior surface may be configured in a variety of shapes and sizes, including, but not limited to: a plurality of voids, each of a characteristic size at least four times smaller than the smallest dimension of the duct cross-section; one or more voids having a dimension larger than one-fourth of the smallest dimension of the duct cross-section but smaller than the dimension of the lighting element along its longitudinal axis; or a combination including at least one of each. In some cases, the plurality of voids can be a perforated film, such as described elsewhere.

The distinction between the “light transport element” and the “lighting element” hereinafter is that the area of light output surface in the light transport element constitutes not more than 2% of the total area interior surface of the cavity defined by the reflective surface; in contrast, the area of light output surface in the lighting element constitutes more than 2% of the total area interior surface of the cavity defined by the reflective surface.

The lighting element may further include additional films, such as a steering film having a plurality of ridges adjacent the turning film and opposite the light output surface, each ridge parallel to the longitudinal axis and disposed to refract an incident light ray from the turning film, wherein a light ray that exits the cavity through the light output surface is redirected by the turning film, and further redirected from the light duct by the steering film, as described elsewhere. Turning films, steering films, and plurality of void configurations are further described, for example, in co-pending U.S. Patent Application Ser. Nos. 61/720,124 entitled CURVED LIGHT DUCT EXTRACTION (Attorney Docket No. 70224US002, filed Oct. 30, 2012), and 61/720,118 entitled RECTANGULAR LIGHT DUCT EXTRACTION (Attorney Docket No. 70058US002, also filed Oct. 30, 2012), the disclosure of which are both herein incorporated in their entirety.

Any suitable reflector can be used in mirror-lined light ducts, including, for example metals or metal alloys, metal or metal alloy coated films, organic or inorganic dielectric films stack, or a combination thereof. In some cases, mirror-lined light ducts can be uniquely enabled by the use of polymeric multilayer interference reflectors such as 3M optical films, including mirror films such as Vikuiti™ ESR film, that have greater than 98% specular reflectivity across the visible spectrum of light. It is widely accepted that LED lighting may eventually replace a substantial portion of incandescent, fluorescent, metal halide, and sodium-vapor fixtures for remote lighting applications. One of the primary driving forces is the projected luminous efficacy of LEDs versus those of these other sources. Some of the challenges to utilization of LED lighting include (1) reduce the maximum luminance emitted by the luminaire far below the luminance emitted by the LEDs (e.g., to eliminate glare); (2) promote uniform contributions to the luminance emitted by the luminaire from every LED in the fixture (i.e., promote color mixing and reduce device-binning requirements); (3) preserve the small etendue of LED sources to control the angular distribution of luminance emitted by the luminaire (i.e., preserve the potential for directional control); (4) avoid rapid obsolescence of the luminaire in the face of rapid evolution of LED performance (i.e., facilitate updates of LEDs without replacement of the luminaire); (5) facilitate access to customization of luminaires by users not expert in optical design (i.e., provide a modular architecture); and (6) manage the thermal flux generated by the LEDs so as to consistently realize their entitlement performance without excessive weight, cost, or complexity (i.e., provide effective, light-weight, and low-cost thermal management).

When coupled to a collimated LED light source, the ducted light-distribution system described herein can address challenges (1)-(5) in the following manners (challenge 6 concerns specific design of the LED lighting element):

(1) The light flux emitted by the LEDs is emitted from the luminaire with an angular distribution of luminance which is substantially uniform over the emitting area. The emitting area of the luminaire is typically many orders of magnitude larger than the emitting area of the devices, so that the maximum luminance is many orders of magnitude smaller.

(2) The LED devices in any collimated source can be tightly clustered within an array occupying a small area, and all paths from these to an observer involve substantial distance and multiple bounces. For any observer in any position relative to the luminaire and looking anywhere on the emitting surface of a luminaire, the rays incident upon your eye can be traced within its angular resolution backwards through the system to the LED devices. These traces will land nearly uniformly distributed over the array due to the multiple bounces within the light duct, the distance travelled, and the small size of the array. In this manner, an observer's eye cannot discern the emission from individual devices, but only the mean of the devices.

(3) The typical orders of magnitude increase in the emitting area of the luminaire relative to that of the LEDs implies a concomitant ability to tailor the angular distribution of luminance emitted by the luminaire, regardless of the angular distribution emitted by the LEDs. The emission from the LEDs is collimated by the source and conducted to the emitting areas through a mirror-lined duct which preserves this collimation. The emitted angular distribution of luminance is then tailored within the emitting surface by the inclusion of appropriate micro structured surfaces. Alternately, the angular distribution in the far field of the luminaire is tailored by adjusting the flux emitted through a series of perimeter segments which face different directions. Both of these means of angular control are possible only because of the creation and maintenance of collimation within the light duct.

(4) By virtue of their close physical proximity, the LED sources can be removed and replaced without disturbing or replacing the bulk of the lighting system.

(5) Each performance attribute of the system is influenced primarily by one component. For example, the shape and size of the light transmissive region or, if used, the local percent open area of a perforated ESR spanning the light output region, determines the spatial distribution of emission, and the shape of optional decollimation-film structures (such as “steering film” structures) largely determines the cross-duct angular distribution. It is therefore feasible to manufacture and sell a limited series of discrete components (e.g., slit or perforated ESR with a series of percent open areas, and a series of decollimation films for standard half angles of uniform illumination) that enable users to assemble an enormous variety of lighting systems.

One component of the light ducting portion of an illumination system is the ability to extract light from desired portions of the light duct efficiently, and without adversely degrading the light flux passing through the light duct to the rest of the ducted lighting system. Without the ability to extract the light efficiently, any remote lighting system would be limited to short-run light ducts only, which could significantly reduce the attractiveness of distributing high intensity light for interior lighting.

For those devices designed to transmit light from one location to another, such as a light duct, it is desirable that the optical surfaces absorb and transmit a minimal amount of light incident upon them while reflecting substantially all of the light. In portions of the device, it may be desirable to deliver light to a selected area using generally reflective optical surfaces and to then allow for transmission of light out of the device in a known, predetermined manner. In such devices, it may be desirable to provide a portion of the optical surface as partially reflective to allow light to exit the device in a predetermined manner, as described herein.

Where multilayer optical film is used in any optical device, it will be understood that it can be laminated to a support (which itself may be transparent, opaque reflective or any combination thereof) or it can be otherwise supported using any suitable frame or other support structure because in some instances the multilayer optical film itself may not be rigid enough to be self-supporting in an optical device.

Control of the emission in the cross-duct direction is available for curved light ducts whose cross section contains a continuum or discrete plurality of outward surface normals from the centerline of the light duct to points on the target illuminated surface(s). In some cases, the turning film can be rolled to form a cylinder and inserted into a smooth-walled transparent tube, with the vertexes of the tapered protrusions facing inward. Then the ESR having a predetermined light transmissive region can be rolled to form a cylinder and inserted inside the turning film. The emission through this light extraction duct is centered about normal to the surface, when the included angle of the tapered protrusions is about 69 degrees. Different circumferential locations on the surface of the light duct can illuminate different localized areas on the target surface. Tailoring the percent open area of the slit or perforated ESR at different locations to alter the local intensity of the emitted luminance provides the means to create desired patterns of illuminance on the target surface.

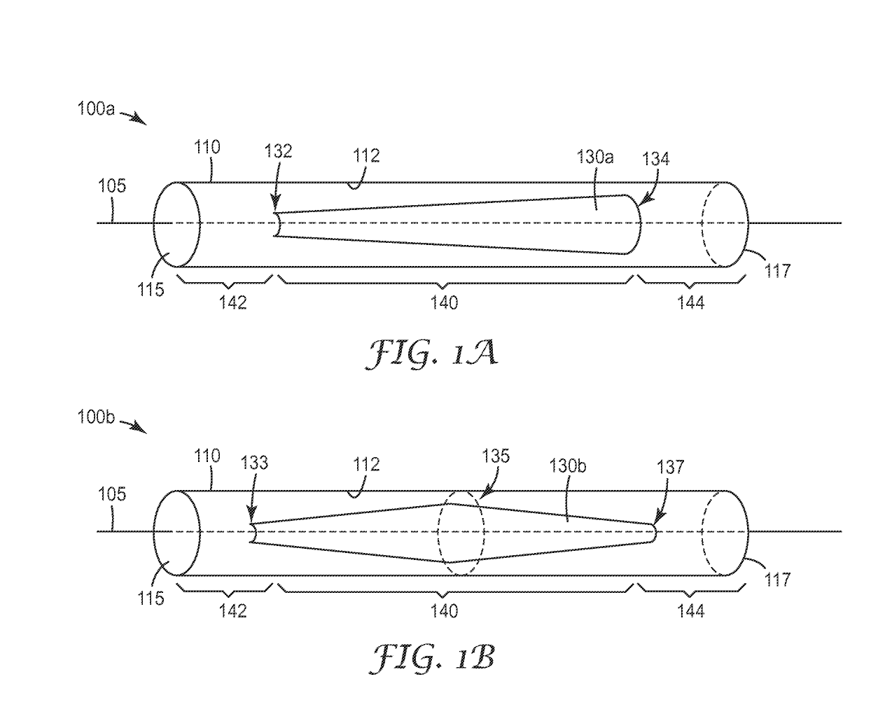

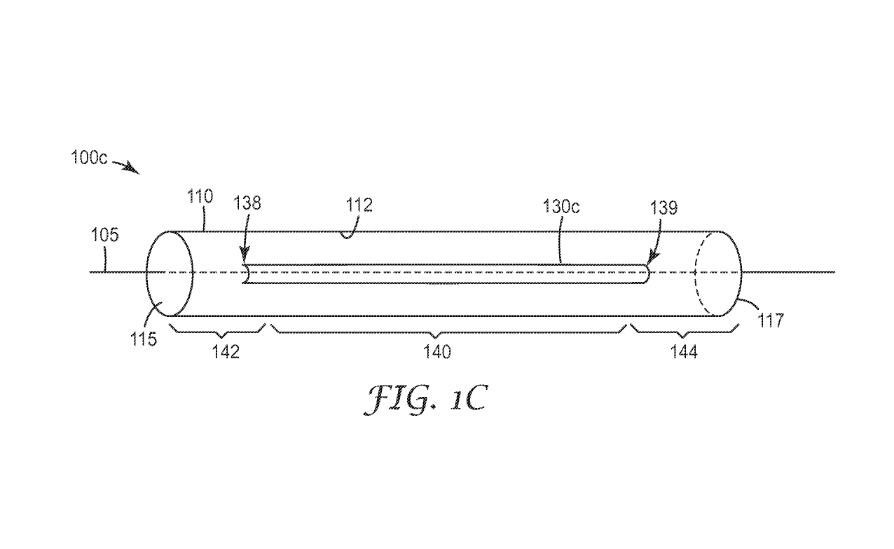

FIGS. 1A-1C shows perspective schematic views of a first, second, and third lighting element 100a, 100b, and 100c, according to one aspect of the disclosure. In FIG. 1A-1C, first, second, and third lighting elements 100a, 100b, 100c, each include a light duct 110 having a longitudinal axis 105, a first end 115, an opposing second end 117, and a reflective inner surface 112. Each of the first, second, and third lighting elements 100a, 100b, 100c further include a first, second, and third light transmissive region 130a, 130b, 130c, respectively, in a light output region 140. An optional light transport region 142, 144, extends between the light output region and each of the first and second ends 115, 117, respectively. Each of the optional light transport regions 142, 144 comprise sections of the light duct 110 in which the reflective inner surface 112 extends completely around the light duct 110, with no accompanying light transmission region, to provide for transport and mixing of light (not shown) entering from either the first or second ends 115, 117.

In one particular embodiment, FIG. 1A shows the first lighting element 100a having the first light transmissive region 130a that increases in size from a first position 132 proximate the first end 115 of the light duct 110 to a second position 134 proximate the second end 117 of the light duct 110. In some cases, the first light transmissive region 130a can be useful for extracting (and more uniformly distributing) light from the first lighting element 100a, that is input from the first end 115 and can reflect from the second end 117.

In one particular embodiment, FIG. 1B shows a second light transmissive region 130b that increases in size from a first position 133 proximate the first end 115 of the light duct 110 to a midpoint position 135, and then decreases in size from the midpoint position 135 to a second position 137 proximate the second end 117 of the light duct 110. In some cases, the second light transmissive region 130b can be useful for extracting (and more uniformly distributing) light from the second lighting element 100b that is input from both the first end 115 and also from the second end 117.

In one particular embodiment, FIG. 1C shows a third light transmissive region 130c that extends from a first position 138 proximate the first end 115 of the light duct 110 to a second position 139 proximate the second end 117 of the light duct 110. The third light transmission region 130c can be uniform in size from the first position 138 to the second position 139, or the size can vary as desired along the length direction parallel to the longitudinal axis 105, to extract any desired distribution of light from the light duct 110. In some cases, the third light transmissive region 130c can be useful for extracting (and more uniformly distributing) light from the third lighting element 100c that is input either from both the first end 115 and the second end 117, or from only one of the first end 115 and second end 117.

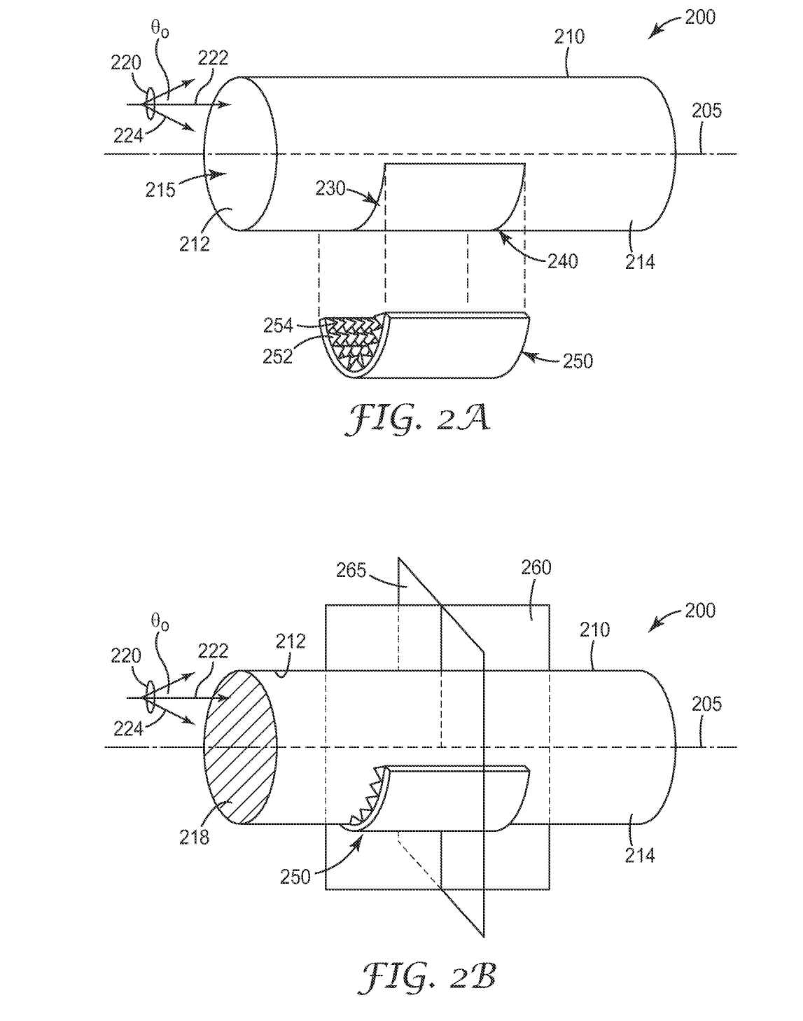

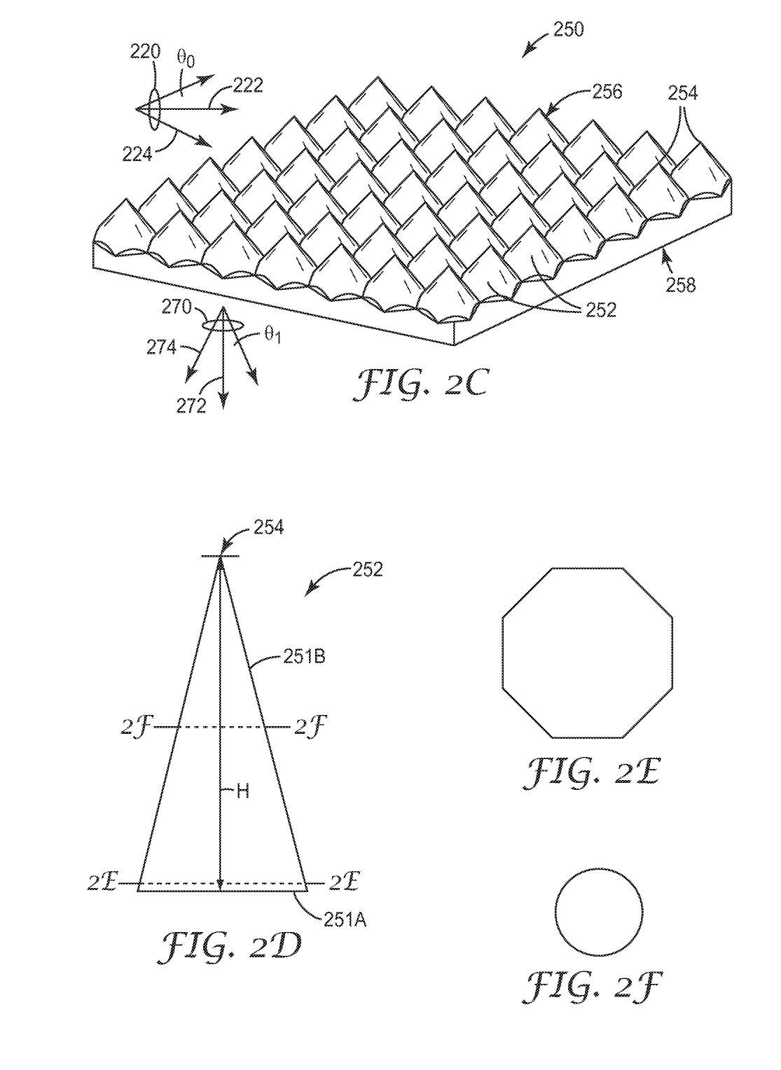

FIG. 2A shows an exploded perspective schematic view of a lighting element 200, according to one aspect of the disclosure. Lighting element 200 includes a light duct 210 having a longitudinal axis 205 and an inner reflective surface 212. A partially collimated light beam 220 having a central light ray 222 and boundary light rays 224 disposed within an input collimation half-angle θ₀ of the longitudinal axis 205 can be efficiently transported along the light duct 210 from the first end 215. A portion of the partially collimated light beam 220 can leave the light duct 210 through a light output region 240 disposed in the inner reflective surface 212 having a light transmissive region 230 where light is extracted. The light transmissive region 230 can be any of the transmissive regions (e.g., 130a, 130b, 130c) described elsewhere, including having a slice removed from the inner reflective surface 212, or a plurality of voids (not shown) in the inner reflective surface 212. A turning film 250 having a plurality of tapered protrusions, such as conical shaped microstructures 252, on a major surface thereof, can be positioned adjacent the light output region 240 such that a vertex 254 corresponding to each of the conical shaped microstructures 252 is positioned proximate an exterior surface 214 of light duct 210. The turning film 250 can intercept light rays exiting the light duct 210 through the light transmissive region 230.

In one particular embodiment, the light transmissive region 230 can be physical apertures, such as holes that pass either completely through, or through only a portion of the thickness of the inner reflective surface 212. In one particular embodiment, the light transmissive region 230 can instead be solid clear or transparent regions such as a window, formed in the inner reflective surface 212 that do not substantially reflect light. In either case, the light transmissive region 230 designates a region of the inner reflective surface 212 where light can pass through, rather than reflect from the surface. The voids in the light transmissive region 230 can have any suitable shape, either regular or irregular, and can include curved shapes such as arcs, circles, ellipses, ovals, and the like; polygonal shapes such as triangles, rectangles, pentagons, and the like; irregular shapes including X-shapes, zig-zags, stripes, slashes, stars, and the like; and combinations thereof.

The light output region 240 can be made to have any desired percent open (i.e., non-reflective) area from about 1% to about 50%. In one particular embodiment, the percent open area ranges from about 1% to about 30%, or from about 1% to about 25%. The size range of the individual voids in a perforated ESR reflector, if used in the light transmissive region 130, can also vary. In one particular embodiment, the voids can range in major dimension from about 0.5 mm to about 5 mm, or from about 0.5 mm to about 3 mm, or from about 1 mm to about 2 mm.

In some cases, the voids can be uniformly distributed across the light transmissive region 230 and can have a uniform size. However, in some cases, the voids can have different sizes and distributions across the light transmissive region 230, and can result in a variable areal distribution of void (i.e., open) across the output region, as described elsewhere. The light transmissive region 230 can optionally include switchable elements (not shown) that can be used to regulate the output of light from the light duct by changing the void open area gradually from fully closed to fully open, such as those described in, for example, co-pending U.S. Patent Publication No. US2012-0057350 entitled, SWITCHABLE LIGHT-DUCT EXTRACTION.

The voids can be physical apertures that may be formed by any suitable technique including, for example, die cut, laser cut, molded, formed, and the like. The voids can instead be transparent windows that can be provided of many different materials or constructions. The areas can be made of multilayer optical film or any other transmissive or partially transmissive materials. One way to allow for light transmission through the areas is to provide areas in optical surface which are partially reflective and partially transmissive. Partial reflectivity can be imparted to multilayer optical films in areas by a variety of techniques.

In one aspect, areas may comprise multi-layered optical film which is uniaxially stretched to allow transmission of light having one plane of polarization while reflecting light having a plane of polarization orthogonal to the transmitted light, such as described, for example, in U.S. Pat. No. 7,147,903 (Ouderkirk et al.), entitled “High Efficiency Optical Devices”. In another aspect, areas may comprise multi-layered optical film which has been distorted in selected regions, to convert a reflective film into a light transmissive film. Such distortions can be effected, for example, by heating portions of the film to reduce the layered structure of the film, as described, for example, in PCT Publication No. WO2010075357 (Merrill et al.), entitled “Internally Patterned Multilayer Optical Films using Spatially Selective Birefringence Reduction”.

The selective birefringence reduction can be performed by the judicious delivery of an appropriate amount of energy to the second zone so as to selectively heat at least some of the interior layers therein to a temperature high enough to produce a relaxation in the material that reduces or eliminates a preexisting optical birefringence, but low enough to maintain the physical integrity of the layer structure within the film. The reduction in birefringence may be partial or it may be complete, in which case interior layers that are birefringent in the first zone are rendered optically isotropic in the second zone. In exemplary embodiments, the selective heating is achieved at least in part by selective delivery of light or other radiant energy to the second zone of the film.

In one particular embodiment, the turning film 250 can be a microstructured film such as, for example, Vikuiti™ Image Directing Films, available from 3M Company. The turning film 250 can include one plurality of parallel ridged microstructure shapes, or more than one different parallel ridged microstructure shapes, such as having a variety of included angles used to direct light in different directions, as described elsewhere.

In one particular embodiment, each vertex 254 can be immediately adjacent the exterior surface 214; however, in some cases, each vertex 254 can instead be separated from the exterior surface 214 by a separation distance (not shown). The turning film 250 is positioned to intercept and redirect light rays exiting the light output region 240. The vertex 254 corresponding to each of the conical shaped microstructures 252 has an included angle that can vary from about 30 degrees to about 120 degrees, or from about 45 degrees to about 90 degrees, or from about 55 degrees to about 75 degrees, or from 65 degrees to about 70 degrees, or about 67 degrees, to redirect light incident on the microstructures. In one particular embodiment, the included angle ranges from about 65 degrees to about 75 degrees and the partially collimated light beam 220 that exits through the light output region 240 is redirected by the turning film 250 away from the longitudinal axis 205 in a direction substantially perpendicular to the longitudinal axis 205.

FIG. 2B shows a perspective schematic view of the lighting element 200 of FIG. 2A, according to one aspect of the disclosure. The perspective schematic view shown in FIG. 2B can be used to further describe aspects of the lighting element 200. Each of the elements 210-250 shown in FIG. 2B correspond to like-numbered elements 210-250 shown in FIG. 2A, which have been described previously. For example, light duct 210 shown in FIG. 2B corresponds to light duct 210 shown in FIG. 2A, and so on. In FIG. 2B, a cross-section 218 of light duct 210 including the exterior 214 is perpendicular to the longitudinal axis 205, and a first plane 260 passing through the longitudinal axis 205 and the turning film 250 is perpendicular to the cross-section 218. In a similar manner, a second plane 265 is parallel to the cross-section 218 and perpendicular to both the first plane 260 and the turning film 250. The turning film 250 accomplishes redirection of the light in a direction that is a combination of turning in both the first plane 260 and the second plane 265. As described herein, cross-section 218 generally includes a light output region 240 that is curved; in some cases, the light output region 240 includes a portion of a circular cross-section, an oval cross-section, or an arced region of a planar-surface light duct, as described elsewhere. Examples of some typical cross-section figures include circles, ellipses, polygons, closed irregular curves, triangles, squares, rectangles or other polygonal shapes.

In some embodiments, the lighting element 200 can further include a plurality of steering elements (not shown) disposed adjacent the turning film 250, such that the turning film 250 is positioned between the steering elements and the exterior 214 of the light duct 210. The steering elements are disposed to intercept light exiting from the turning film 250 and provide further angular spread of the light in a radial direction (i.e., in directions within second plane 265), such as described in U.S. Provisional Patent Application Ser. No. 61/720,118 entitled RECTANGULAR DUCT LIGHT EXTRACTION (Attorney Docket No. 70058US002, filed Oct. 30, 2012).

FIG. 2C shows a perspective schematic of a turning film 250, according to one aspect of the disclosure. Turning film 250 includes a turning surface 256 and an opposing surface 258, the turning surface 256 including a plurality of conical microstructures 252, each of the conical microstructures 252 having a vertex 254. A partially collimated input light beam 220 having a collimation half-angle θ₀, central input light ray 222, and boundary light rays 224, that propagates in a direction generally parallel to the turning film 250 can be redirected by the turning film 250. The redirected light exits as output light beam 270 having a collimation half-angle θ₁, central input light ray 272, and boundary light rays 274, that propagates in a direction generally perpendicular to the turning film 250.

The conical microstructures may be arranged in any suitable pattern, for example in a series of rows and columns, randomly distributed across the turning surface, or alternating rows and columns as in a hexagonal close-packed pattern as shown in FIG. 2C. In some cases, the conical microstructures may be arranged in a pattern such that there is a planar portion on the turning surface between adjacent conical microstructures, or the conical microstructures can be packed closely, such that no planar portion is present between adjacent conical microstructures.

Any suitable visible-light transmissive material may be used to form the conical microstructures. In some cases, suitable materials may include optical polymers such as acrylate, polycarbonate, polystyrene, styrene acrylonitrile, and the like. In some cases, the material may have a refractive index between approximately 1.4 and about 1.7, such as, for example, between about 1.45 and about 1.6.

FIG. 2D shows a cross-sectional schematic view of a conical shaped microstructure 252 through the vertex 254, FIG. 2E shows a cross-sectional slice through section 2E in FIG. 2D, and FIG. 2F shows a cross-sectional slice through section 2F in FIG. 2D, according to one aspect of the disclosure. Conical shaped microstructure 252 can be in a hexagonal close-packed array, and the cross-sectional view through the base 251A is shown in FIG. 2E as a hexagon. The cross-section changes along the height “H” and the cross-sectional view proximate the vertex 254 is shown in FIG. 2F as a circle. It is to be understood that for non-conical tapered protrusions, other cross-sectional shapes may occur moving up the height direction; however, the cross-sectional areas will decrease as distance from the base is increased, as described elsewhere.

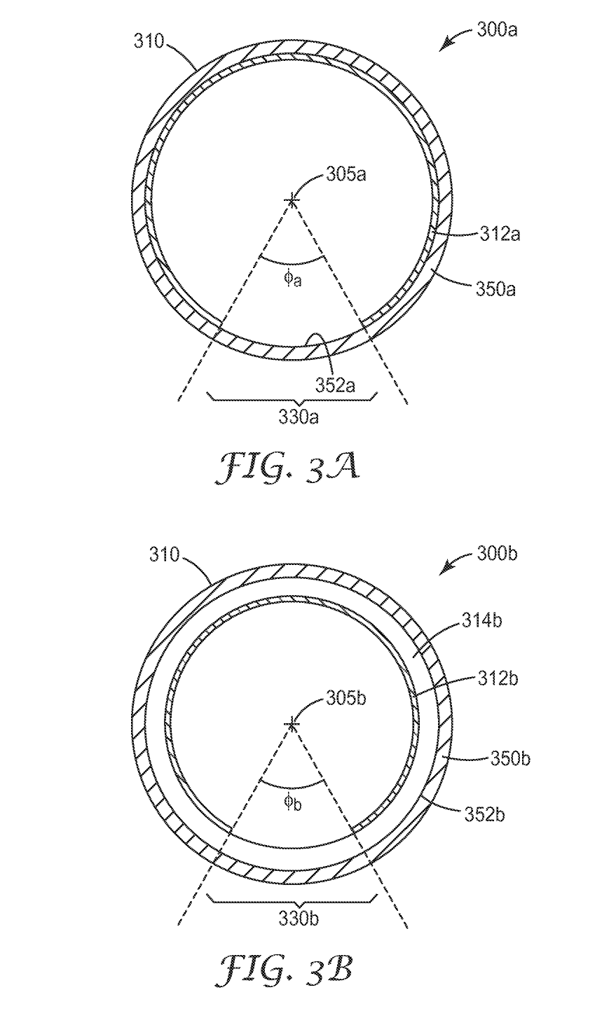

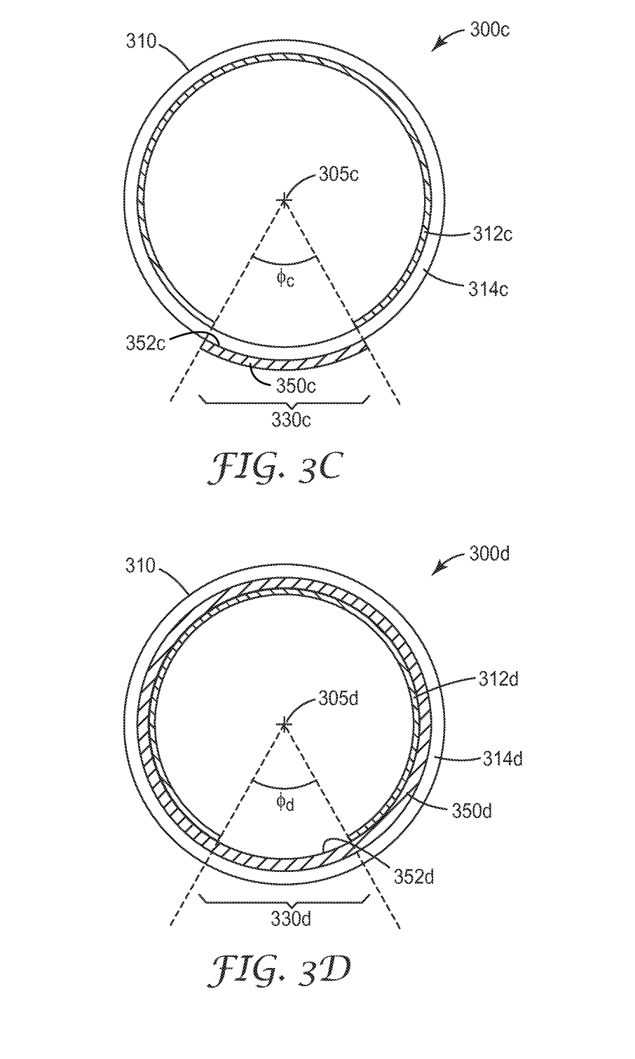

FIGS. 3A-3D shows cross-sectional schematic embodiments of first through fourth lighting elements 300a, 300b, 300c, and 300d, according to one aspect of the disclosure. Each of the first through fourth lighting elements 300a, 300b, 300c, and 300d include a longitudinal axis 305a, 305b, 305c, 305d, a light transmissive region 330a, 330b, 330c, 330d, and an output angle (φa, φb, φc, φd, respectively, as described elsewhere. Each of the output angles φa, φb, φc, φd are measured perpendicular to the respective longitudinal axis 305a, 305b, 305c, 305d, and represent the radial angular spread of light exiting the light duct 310 through the light transmissive region 330a, 330b, 330c, 330d.

In FIG. 3A, the light duct 310 is formed by wrapping the turning film 350a into a cylinder such that the conical shaped microstructures 352a face inward, and positioning a rolled inner reflector film 312a, such as ESR film within the cylinder.

In FIG. 3B, the light duct 310 is formed by wrapping the turning film 350b into a cylinder around a transparent tube 314b such as an acrylic, polycarbonate, or glass tube, such that the conical shaped microstructures 352b face inward, and positioning a rolled inner reflector film 312b, such as ESR film within the cylinder.

In FIG. 3C, the light duct 310 is formed by wrapping the turning film 350c around a transparent tube 314c in the light transmissive region 330c, such that the conical shaped microstructures 352c face inward, and positioning a rolled inner reflector film 312c, such as ESR film within the cylinder. The transparent tube 314c can be any suitable transparent material such as an acrylic, polycarbonate, or a glass tube.

In FIG. 3D, the light duct 310 is formed by wrapping the turning film 350d into a cylinder and placing the rolled tube within a transparent tube 314d, such that the conical shaped microstructures 352d face inward, and positioning a rolled inner reflector film 312d, such as ESR film within the turning film 350d. The transparent tube 314d can be any suitable transparent material such as an acrylic, polycarbonate, or a glass tube. In some cases, the configuration shown in FIG. 3D can be preferable, since this configuration can be most readily adapted to a hermetically sealed lighting element 300d, by affixing sealing ends to the light duct 310, as described elsewhere.

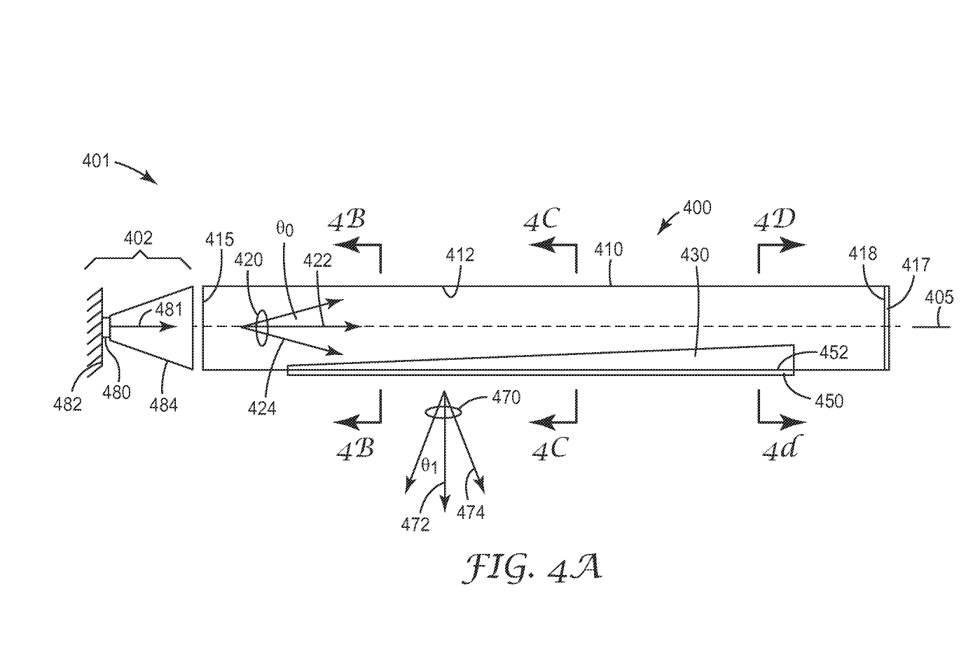

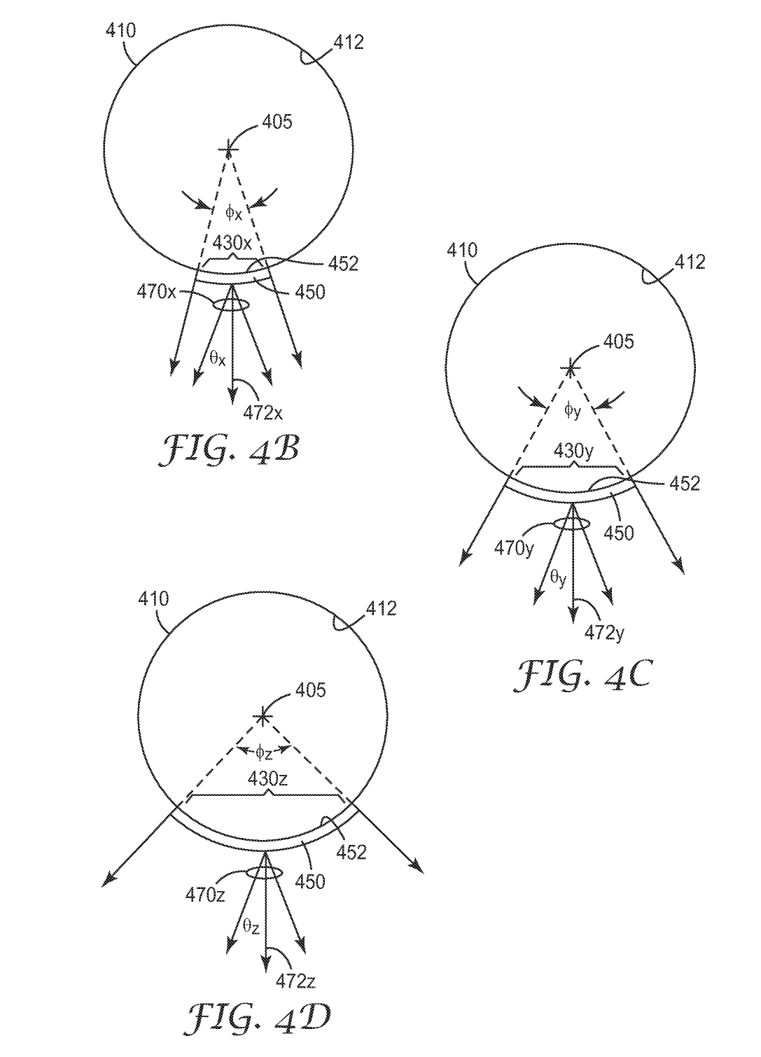

FIG. 4A shows a schematic cross-sectional longitudinal view of a remote illumination light duct 401, according to one aspect of the disclosure. Remote illumination light duct 401 includes a light injector 402 and a lighting element 400. Light injector 402 includes a light source 480 mounted on a heat extraction element 482, and light collimation optics 484. In some cases, the light collimation optic 484 may be a truncated cone, as shown in the figure; in other cases, any other suitable light collimation optics as known to those of skill in the art may be used. Lighting element 400 includes a light duct 410 having a longitudinal axis 405, an inner reflective surface 412, first end 415, opposing second end 417, and a light transmissive region 430, as described elsewhere. Opposing second end 417 can include an optional reflector 418 to reflect light rays, or it can be transparent so that a second light injector (not shown) can be used to input light into the light duct 410, as described elsewhere.

Lighting element 400 further includes a turning film 450 having a plurality of conical shaped microstructures 452 facing inward toward the longitudinal axis 405 and positioned adjacent the light transmissive region 430. Light source 480 can typically be an LED that injects light 481 through the light collimation optics 484 and into the first end 415 of the light duct 410 as partially collimated light beam 420 having a central light ray 422, boundary light ray 424 and collimation angle θ₀. Light rays intersecting the light transmissive region 430 are turned by the turning film 450 and exit the lighting element 400 as output light rays 470 having a central output light ray 472, boundary light ray 474, and collimation angle θ₁. The light transmissive region 430 can vary in size along the longitudinal axis 405, as described elsewhere, and cross-sections of lighting element 400 are shown in FIGS. 4B-4D.

In one particular embodiment, partially collimated light beam 420 includes a cone of light having a propagation direction within an input light divergence angle θ₀ (i.e., a collimation half-angle θ₀) from central light ray 422. The divergence angle θ₀ of partially collimated light beam 420 can be symmetrically distributed in a cone around the central light ray 422, or it can be non-symmetrically distributed. In some cases, the divergence angle θ₀ of partially collimated light beam 420 can range from about 0 degrees to about 30 degrees, or from about 0 degrees to about 25 degrees, or from about 0 degrees to about 20 degrees, or even from about 0 degrees to about 15 degrees. In one particular embodiment, the divergence angle θ₀ of partially collimated light beam 420 can be about 23 degrees.

Partially collimated light rays are injected into the interior of the light duct 410 along the direction of the longitudinal axis 405 of the light duct 410. In some cases, a perforated reflective lining of the light duct (e.g., perforated 3M Enhanced Specular Reflector (ESR) film) lines the light duct 410 in the light transmissive region 430. A light ray which strikes the ESR between perforations is specularly reflected and returned to the light duct within the same cone of directions as the incident light. Generally, the reflective lining of ESR is at least 98 percent reflective at most visible wavelengths, with no more than 2 percent of the reflected light directed more than 0.5 degrees from the specular direction. A light ray which strikes within a perforation passes through the ESR with no change in direction. (Note that the dimensions of the perforations within the plane of the ESR are assumed large relative to its thickness, so that very few rays strike the interior edge of a perforation.) The probability that a ray strikes a perforation and therefore exits the light duct is proportional to the local percent open area of the perforated ESR. Thus, the rate at which light is extracted from the light duct can be controlled by adjusting this percent open area.

The half angle in the circumferential direction is comparable to the half angle of collimation within the light duct. The half angle in the longitudinal direction is approximately one-half the half angle within the light duct; i.e., only half of the directions immediately interior to the ESR have the opportunity to escape through a perforation. Thus, the precision of directing the light in a desired direction increases as the half angle within the light duct decreases.

Light rays that pass through a perforation next encounter a turning film having a turning surface with a plurality of tapered protrusiona. The light rays strike the tapered protrusions of the turning film in a direction substantially parallel to the plane of the turning film and perpendicular to the axes of the tapered protrusions—the divergence of their incidence from this norm is dictated by the collimation within the light duct. A majority of these rays enter the film by refracting through the tapered protrusion surface, then undergoing total internal reflection (TIR) from within the tapered protrusions, and finally refracting through the bottom of the film. There can also be a net change in the direction of propagation perpendicular to the axis of the light duct, so the turning of the light beam can occur in the combination of two orthogonal planes, as described elsewhere, for example with reference to FIG. 2B. The net change in direction along the axis and perpendicular to the axis of the light duct can be readily calculated by using the index of refraction of the turning film tapered protrusion material and the vertex angle of the prisms. In general these are selected to yield an angular distribution of transmission centered about the normal to the film. Since most rays are transmitted, very little light is returned to the light duct, facilitating the maintenance of collimation within the light duct.

If desired, light rays that pass through the turning film can next encounter an optional decollimation film or plate (also referred to as a steering film), as described in U.S. Provisional Patent Application Ser. No. 61/720,118 entitled RECTANGULAR DUCT LIGHT EXTRACTION (Attorney Docket No. 70058US002, filed Oct. 30, 2012), although generally all turning/steering functions can be accomplished by the tapered protrusion surface of the turning film. However, in some cases, an additional steering film can be used. The rays encountering the steering film strike the structured surface of this film substantially normal to the plane of the film. The majority of these pass through the structured surface, are refracted into directions determined by the local slope of the structure, and pass through the bottom surface. For these light rays, there can be, if desired, no net change in the direction of propagation along the axis of the light duct. The net change in direction perpendicular to the axis is determined by the index of refraction and the distribution of surface slopes of the structure. The steering film structure can be a smooth curved surface such as a cylindrical or aspheric ridge-like lens, or can be piecewise planar, such as to approximate a smooth curved lens structure. In general the steering film structures are selected to yield a specified distribution of illuminance upon target surfaces occurring at distances from the light duct large compared to the cross-duct dimension of the emissive surface. Again, since most rays are transmitted, very little light is returned to the light duct, preserving the collimation within the light duct.

In many cases the turning film and steering film, if present, may use a transparent support plate or tube surrounding the light duct (depending on the light duct configuration). In one particular embodiment, the transparent support can be laminated to the outermost film component, and can include an anti-reflective coating on the outermost surface. Both lamination and AR coats increase transmission through and decrease reflection from the outermost component, increasing the overall efficiency of the lighting system, and better preserving the collimation within the light duct.

FIGS. 4B-4D shows schematic views through different cross-sections of FIG. 4A, according to one aspect of the disclosure, where the output angle φ that is subtended in a direction perpendicular to the longitudinal axis 405, increases from φx at position 4B, to φy at position 4C, to φz at position 4D.

The vertex corresponding to each of the conical shaped microstructures 452 has an included angle between planar faces of the conical shaped microstructures 452 that can vary from about 30 degrees to about 120 degrees, or from about 45 degrees to about 90 degrees, or from about 55 degrees to about 75 degrees, or from 65 degrees to about 70 degrees, or about 67 degrees, to redirect light incident on the microstructures. In one particular embodiment, the included angle ranges from about 65 degrees to about 75 degrees and the partially collimated light beam that exits through the light transmissive region 430x, 430y, 430z is redirected by the turning film 450 away from the longitudinal axis 405.

The redirected portion of the partially collimated light beam exits as a partially collimated output light beam 470x, 470y, 470z having a central light ray 472x, 472y, 472z and an output collimation half-angle φₓ, φ_{y}, φ_{z} and directed at a longitudinal angle from the longitudinal axis 405 (i.e., along an angle measured perpendicular from the longitudinal axis in a plane containing the longitudinal axis and the central light ray 472x, 472y, 472z). In some cases, the input collimation half-angle θ₀ and the output collimation half angle θₓ, θ_{y}, θ_{z} can be the same, and the collimation of light is retained. The longitudinal angle from the longitudinal axis can vary from about 45 degrees to about 135 degrees, or from about 60 degrees to about 120 degrees, or from about 75 degrees to about 105 degrees, or can be approximately 90 degrees, depending on the included angle of the microstructures.

Formulas can be readily derived that form the basis for an approximate analytic model of the angular distribution of luminance extracted, and its dependence upon the half angle of collimation within the light duct, the index and included angle of the turning film, and the index and slope distribution of the optional decollimation film. The impacts of ray paths other than the principal path, subtle differences in index between the resins, substrates, and support plates within the curved light extractor, the potential for absorption within these components, and the presence of additional features such as the AR coat on the support plate can all be assessed by photometric ray-trace simulation. Predictions of well-executed simulations can be essentially exact insofar as the input descriptions of components and their assembly are accurate.

Generally, the half angle in the along-duct direction of the emission through any lighting element disclosed herein is approximately one-half the half angle of the collimation within the light duct, since typically only one-half of the rays within the cone of rays striking the void will exit the light duct. In some cases, it can be desirable to increase the half angle in the along-duct direction without altering the angular distribution emitted in the cross-duct direction. Increasing the half angle in the along-duct direction will elongate the segment of the emissive surface which makes a substantive contribution to the illuminance at any point on a target surface. This can in turn diminish the occurrence of shadows cast by objects near the surface, and may reduce the maximum luminance incident upon the surface, reducing the potential for glare. It generally is not acceptable to increase the half angle along the light duct by simply increasing the half angle within the light duct, as this would alter the cross-duct distribution and ultimately degrade the precision of cross-duct control.

For example, the along-duct distribution is centered approximately about normal for index-1.6, 69-degree vertex angle for a conical shaped microstructures turning film. It is centered about a direction with a small backward component (relative to the sense of propagation within the light duct) for included angles less than 69 degrees, and about a direction with a forward component for included angles greater than 69 degrees. Thus, a turning film composed of tapered protrusions with a plurality of included angles, including some less than 69 degrees and some greater than 69 degrees, can produce an along-duct distribution approximately centered about normal, but possessing a larger along-duct half angle than a film composed entirely of 69-degree tapered protrusions.

FIG. 5 shows a cross-sectional schematic embodiment of a lighting element 500 having a curved light output region 580, according to one aspect of the disclosure. In FIG. 5, lighting element 500 includes a rectangular light duct 510 having a longitudinal axis 515, a reflective interior surface 512, and a curved light output region 580. The curved light output region 580 includes a light transmissive region 530, as described elsewhere. A turning film 550 is disposed adjacent the light transmissive region 530. An output angle φ is subtended perpendicularly from the longitudinal axis 515 and represents the angular spread of light exiting the rectangular light duct 510. Partially collimated light propagating along the direction of the longitudinal axis 515 which intercepts the light transmissive region 530, exits the rectangular light duct 510 as partially collimated light 570 having a central light ray 572, boundary light ray 574, and collimation angle θ1. The central light ray 572 generally exits in a direction perpendicular to the turning film 550. It is to be understood that the rectangular light duct 510 is representative of a variety of cross-sectional shapes including planar portions, and is intended to also represent other envisioned light duct cross-sections having planar portions including triangular, rectangular, square, pentagonal, and the like cross-sections.

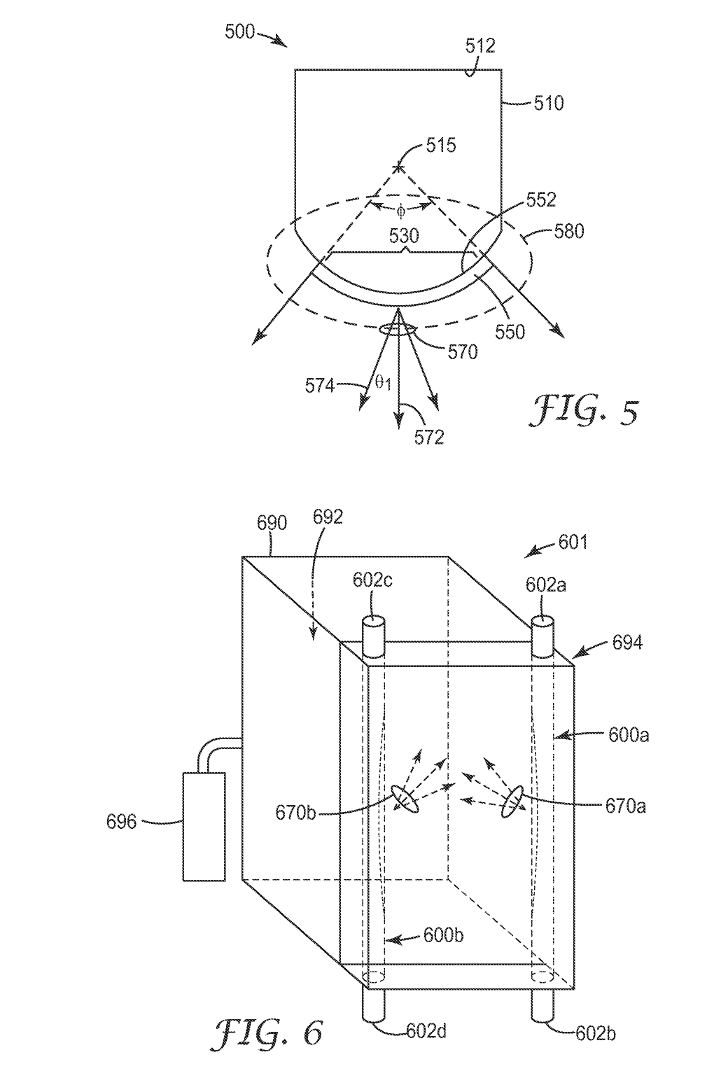

FIG. 6 shows a perspective schematic view of an enclosure 601, according to one aspect of the disclosure. Enclosure 601 can be any of the enclosures described elsewhere, that may benefit from having a remote illumination source. In one particular embodiment, enclosure 601 can be a refrigerated enclosure 601 such as a beverage cooler 690 having a temperature controlled interior space 692, a door 694, and a refrigeration unit 696 to control the temperature of the interior space 692. Refrigerated enclosure 601 can include one or more transparent viewing panels to enable the interior contents to be seen, such as a visible light transparent port in the door 694. One or more remote illumination light ducts can be placed to illuminate the interior space 692, such as the first and second remote illumination light ducts 600a, 600b that are shown to be mounted within the door 694. It is to be understood that any desired number of remote illumination light ducts can be used to illuminate the interior space 692, and they can be placed within the enclosure 601 wherever desired and in whatever orientation is desired including, for example, horizontally, vertically, diagonally, and the like. First and second remote illumination light ducts 600a, 600b include a first pair of light sources 602a, 602b, and a second pair of light sources 602c, 602d, respectively, mounted such that each light source is located exterior to the interior space 692. In this manner, first and second partially collimated output light 670a, 670b, can illuminate the interior space 692 as described elsewhere.

### EXAMPLES

### Example 1

### Beverage Cooler Illuminator

A remote duct lighting system was configured to illuminate the merchandise on the shelves of a “merchandiser”, which is a trade name for a beverage cooler with transparent front door, used in retail settings. A currently available merchandiser used an array of approximately hundreds of LEDs disposed inside the cooling chamber. A measurement determined that the LED array consumed about 34 watts of electrical power, most of which was dissipated as heat inside the cooler. Further energy consumption was associated with the need to remove heat produced by the LEDs from the chilled chamber. This “energy tax” is commonly quantified using a Coefficient of Performance (or COP), which for currently available coolers is typically between 2 and 6 (i.e., one watt of electricity spent on running the refrigerator removes from two to six watts of thermal energy from inside the refrigeration chamber). As a result, an expected savings associated with “remoteness”, i.e. placing the source of light outside the cooling chamber, was likely to vary from about 15 to about 50% of the thermal load produced by the light source.

### Comparative Example

The energy usage of a conventional cooler was determined. In the conventional cooler, 4 strings of LED strips were disposed around the inside of the door. The strips were modular circuit boards with LED circuits, connected with either board-to-board connectors or board-to-wire connectors. Each of the LED circuits comprised 6 LEDs and two resistors connected in series strings. Series strings were connected in parallel, resulting in multiple strings per board. There were 49 circuits comprising a total of 294 LEDs and 98 resistors. The 49 circuits were connected in parallel to a voltage source producing a driving voltage of 24 V.

Voltage drop on 6 serially connected LEDs was measured as 18.6 V, with the balance of 5.4 V dropping on the two resistors. With 30 mA measured current through each circuit, the Joule heat produced by the resistors was estimated to be about 0.162 W. Total energy consumed by the LEDs was 0.558 W, and assuming the photonic efficiency of the LEDs to be about 33%, the estimate for Joule heat produced by the 6 LEDs was 0.372 W. Thus, estimated total Joule heat produced by each LED circuit was 0.162+0.372=0.534 W, so that the total joule heat produced by the 49 circuits was 26.2 W. Measured total power consumed for driving by the LED strips was 33.8 W.

The COP for this cooler was provided as being about 1, so the system (heat pump and the rest) spends 1 W of energy for removing 1 W of heat from inside the cooled chamber into ambient. Therefore, the system expended an additional 26.2 W to remove the heat from inside the cool chamber. The sum of 35 W used to drive the lighting circuit and 26.4 W spent for removing lighting-generated heat from inside the cooler provided a baseline for the energy budget as about 60 W.

### Remote Illumination Energy Usage

Light engines were assembled by placing Cree XM-L LEDs rated at 10 watts electrical power (available from Cree, Inc., Morrisville N.C.) on heat sinks. A total of four such light sources were prepared, each driven at about 3 watts. Rose series collimators (part no. FA11910_CXM-D produced by LEDiL, SALO, FI) were assembled directly on the LEDs, according to their specification.

Two light ducts were fabricated by inserting a cut highly reflective multi-layer film, (Vikuitiâ ESR, available from 3M Company, St. Paul, Minn.) inside cast acrylic tubes, each about 60 cm in length with an outside diameter of 1 inch (2.54 cm) and an inside diameter of ⅞ inch (2.23 cm). A light turning film was disposed between the reflective film and the tube (as shown, for example, in FIG. 3D). The structured surface of the light turning film comprised an array of triangular prisms with 69 degree included vertex angle, with the prisms disposed tangentially to the cross-section of the duct, vertex pointing inside. Two of the light engines with collimators were attached to the ends of each duct, for a total of four light engines used to illuminate the cooler.

The ESR film was cut so that when inserted inside the acrylic tube, a truncated diamond shaped light output surface resulted, similar to that shown in FIG. 1B. The midpoint largest light output angle (i.e., corresponding to position 135) was approximately 90 degrees, and the smallest light output angle near each end (i.e., corresponding to positions 133 and 137) was approximately 45 degrees. The light transport regions (i.e., elements 142 and 144) spanned a distance of approximately 0 cm from each respective end.

The midpoint opening was designed to be less than or equal to one fourth of the total internal duct circumference, thus defining output angle not greater than 90 degrees. This condition was defined by the geometry of application, wherein the light from the duct was placed at the edge of cooler space door, adjacent to the cooler wall and the door glass. Since the purpose of the lighting system was to illuminate the merchandise placed on the merchandiser shelves, the light output from the tube did not hit the inside wall of the cooler, and also was not coupled out towards the viewer through the glass.

The described system provided similar uniformity and illuminance to the Comparative Eample, using only 4 LEDs driven at˜3 W each, totaling 12 W. Because the LEDs were placed outside the chilled volume, no energy was spent for removing heat generated by the circuit from inside the cooler. Thus, total energy budget for lighting the cooler was 12 W.

In some cases, particularly when retrofitting existing beverage coolers with light-tube lighting, it may be impractical for a technician to make mechanical modifications to the cooler door. In such cases, the LEDs could instead be placed inside the cooled space, and the heat load of the 4 LEDs would be added to the total energy budget. Generally, about 75% of the energy delivered by a driver circuit to an XM-L LED (as used above) is converted to heat. Thus, when 4 LEDs are driven at a total 12 W, about 9 W of heat is produced inside the cooler. Assuming that the cooler COP is about 1, about 9 W is expended to eliminate this heat from inside the cooler. In such a case, total energy savings are reduced from 48 W to about 39 W.

### Example 2

### Remote Illumination Energy Efficiency

Light engines were assembled by placing Cree XM-L LEDs rated at 10 watts electrical power (available from Cree, Inc., Morrisville N.C.) on heat sinks Rose series collimators (part no. FA11910_CXM-D produced by LEDiL, SALO, FI) were assembled directly on the LEDs, according to their specification.

Two light ducts were fabricated by inserting a cut highly reflective multi-layer film, (Vikuiti™ ESR, available from 3M Company, St. Paul, Minn.) inside cast acrylic tubes, each about 60 cm in length with an outside diameter of 1 inch (2.54 cm) and an inside diameter of ⅞ inch (2.23 cm). The ESR film was cut so that when inserted inside the acrylic tube, a truncated diamond shaped light output surface resulted, similar to that shown in FIG. 1B. The midpoint largest light output angle (i.e., corresponding to position 135) was approximately 90 degrees, and the smallest light output angle near each end (i.e., corresponding to positions 133 and 137) was approximately 45 degrees. The light transport regions (i.e., elements 142 and 144) spanned a distance of approximately 0 cm from each respective end. The midpoint opening was designed to be less than or equal to one fourth of the total internal duct circumference, thus defining output angle not greater than 90 degrees.

A light turning film was disposed between the reflective film and the tube (as shown, for example, in FIG. 3D) on one of the ducts to make a Control Light Tube having linear turning film. The structured surface of the light turning film comprised an array of triangular prisms with 69 degree included vertex angle, with the prisms disposed tangentially to the cross-section of the duct, vertex pointing inside. One of the light engines was positioned on each end of the light duct.

A light turning film was disposed between the reflective film and the tube (as shown, for example, in FIG. 3D) on one of the ducts to make an Example 2 Light Tube using a conical microstructure turning film. The structured surface of the conical microstructure turning film comprised an array of cones having a 67 degree included vertex angle, a 20 micron height, packed in a hexagonal close-packed array, with the vertex pointing inside the duct. One of the light engines was positioned on each end of the light duct.

A Total Luminous Flux (TLF) measurement was made using an OL 770-LED detector (available from Gooch & Housego, Ilminster, UK) with a custom assembled 2-meter Integrating sphere. The light output was measured for bare LEDs facing away from the detector, collimated light engines (LED+collimator) facing away from the detector, and with the assembled Light Tubes having the outlet aperture facing away from the detector. In each case, three measurements were made, corresponding to an input current of 200 mA, 350 mA, and 300 mA.

A collimator efficiency was defined from a slope of linear fit to dependence of the TLF of collimated light on the TLF of the bare LED, for the three input currents tested. The linear fit was computed in Excel by choosing a linear trend line with a set intercept through (0,0). The calculated efficiency of the collimator assembly varied from about 86% to about 89%.

A light tube efficiency for the Control and for the Example 2 Light Tube was determined from the slopes of dependencies of the integrated light output from the tube versus TLF injected into each tube through the collimator. The Control Light Tube had an efficiency of about 85.7%. The Example 2 Light Tube had a higher efficiency of about 91.8%.

Following are a list of embodiments of the present disclosure.

Item 1 is a lighting element, comprising: a hollow light duct having a longitudinal axis, opposing first and second ends, a light output region, and a curved cross-section; an interior surface of the hollow light duct including a light transmissive region adjacent the light output region, the light transmissive region subtending an output angle perpendicular to the longitudinal axis from a first position proximate the first end to a second position proximate the second end; and a turning film disposed adjacent the light output region, the turning film having a turning surface comprising tapered protrusions, each having a vertex adjacent the interior of the hollow light duct, wherein light rays propagating through the hollow light duct that intersect the light transmissive region, exit the hollow light duct and are redirected by the turning film to a direction substantially normal to the longitudinal axis.

Item 2 is the lighting element of item 1, wherein the interior surface comprises a light reflective surface selected from a metal, a metal alloy, a dielectric film stack, or a combination thereof.

Item 3 is the lighting element of item 1 or item 2, further comprising a first light source positioned proximate the first end capable of injecting a first light into the hollow light duct.

Item 4 is the lighting element of item 1 to item 3, wherein the second end comprises a reflector, and the output angle increases from the first position to the second position.

Item 5 is the lighting element of item 1 to item 4, wherein the output angle increases in a range from about 0 degrees at the first position to about 90 degrees at the second position.

Item 6 is the lighting element of item 1 to item 5, further comprising a second light source positioned proximate the second end capable of injecting a second light into the hollow light duct, and wherein the output angle increases from the first position to a midpoint position and decreases from the midpoint position to the second position.

Item 7 is the lighting element of item 6, wherein the output angle increases in a range from about 0 degrees at the first position to about 90 degrees at the midpoint position, and then decreases in a range from about 90 degrees at the midpoint position to about 0 degrees at the second position.

Item 8 is the lighting element of item 1 to item 7, further comprising a light transport region between the first end and the first position, between the second end and the second position, or between both.

Item 9 is the lighting element of item 1 to item 8, wherein the light transmissive region comprises a plurality of voids.

Item 10 is the lighting element of item 1 to item 9, wherein the light transmissive region comprises a perforated enhanced specular reflective (ESR) film.

Item 11 is the lighting element of item 1 to item 10, wherein the interior surface comprises the turning surface.

Item 12 is the lighting element of item 11, wherein the turning surface comprises a major surface of the turning film, and an opposing major surface of the turning film is adjacent the interior surface of the hollow light duct.

Item 13 is the lighting element of item 1 to item 12, wherein each of the tapered protrusions are adjacent an exterior surface of the hollow light duct.

Item 14 is the lighting element of item 1 to item 12, wherein each of the tapered protrusions are immediately adjacent an exterior surface of the hollow light duct.

Item 15 is the lighting element of item 1 to item 14, wherein light rays propagate in a light duct propagation direction within a first collimation half-angle of the longitudinal axis, and exit in an exit propagation direction that is different than the light duct propagation direction, the exit propagation direction having a second collimation half-angle.

Item 16 is the lighting element of item 15, wherein the second collimation half-angle is greater than the first collimation half-angle.

Item 17 is the lighting element of item 1 to item 16, wherein the curved cross-section comprises a circle, an oval, an ellipse, an arc, or a combination thereof.

Item 18 is the lighting element of item 1 to item 17, wherein the hollow light duct is sealed from an ambient environment.

Item 19 is the lighting element of item 1 to item 18, wherein the tapered protrusions comprise conical shaped microstructures.

Item 20 is the lighting element of item 19, wherein the conical shaped microstructures have a hexagonal base cross-section, a circular cross-section proximate the vertex, and a transitional cross-section therebetween.

Item 21 is the lighting element of item 19 or item 20, wherein the conical shaped microstructures have a vertex included angle of about 67 degrees.

Item 22 is an enclosure, comprising: an interior space; a lighting element disposed in the interior space, the lighting element comprising: a hollow light duct having a longitudinal axis, opposing first and second ends, a light output region, and a curved cross-section; an interior surface of the hollow light duct including a light transmissive region adjacent the light output region, the light transmissive region subtending an output angle perpendicular to the longitudinal axis that changes from a first position proximate the first end to a second position proximate the second end; a turning film disposed adjacent the light output region, the turning film having a turning surface comprising tapered protrusions, each having a vertex adjacent the interior surface of the hollow light duct; and a first light source disposed exterior to the interior space and adjacent the first end, capable of injecting a first light into the hollow light duct within a first collimation half-angle of the longitudinal axis, wherein light rays propagating through the hollow light duct that intersect the light transmissive region, exit the hollow light duct and are redirected by the turning film to a direction substantially normal to the longitudinal axis.

Item 23 is the enclosure of item 22, wherein the tapered protrusions comprise conical shaped microstructures.

Item 24 is the enclosure of item 22 or item 23, wherein the interior space is temperature controlled.

Item 25 is the enclosure of item 22 to item 24, further comprising a second light source positioned proximate the second end and exterior to the interior space, capable of injecting a second light into the hollow light duct, and wherein the output angle increases from the first position to a midpoint position and decreases from the midpoint position to the second position.

Item 26 is the enclosure of item 22 to item 25, wherein the hollow light duct is sealed from an ambient environment.

Item 27 is a refrigerated enclosure, comprising: an interior space; a visible light transparent viewing port; a lighting element disposed in the interior space, the lighting element comprising: a hollow light duct having a longitudinal axis, opposing first and second ends, a light output region, and a curved cross-section; an interior surface of the hollow light duct including a light transmissive region adjacent the light output region, the light transmissive region subtending an output angle perpendicular to the longitudinal axis that changes from a first position proximate the first end to a second position proximate the second end; a turning film disposed adjacent the light output region, the turning film having a turning surface comprising tapered protrusions, each having a vertex adjacent the interior surface of the hollow light duct; and a first light source disposed exterior to the interior space and adjacent the first end, capable of injecting a first light into the hollow light duct within a first collimation half-angle of the longitudinal axis, wherein light rays propagating through the hollow light duct that intersect the light transmissive region, exit the hollow light duct and are redirected by the turning film to a direction substantially normal to the longitudinal axis.

Item 28 is the refrigerated enclosure of item 27, wherein the tapered protrusions comprise conical shaped microstructures.

Item 29 is the refrigerated enclosure of item 27 or item 28, wherein the visible light transparent viewing port comprises a windowed door.

Item 30 is the refrigerated enclosure of item 27 to item 29, wherein the hollow light duct is sealed from an ambient environment.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1 A lighting element, comprising:
a hollow light duct having a longitudinal axis, opposing first and second ends, a light output region, and a curved cross-section;
an interior surface of the hollow light duct including a light transmissive region adjacent the light output region, the light transmissive region subtending an output angle perpendicular to the longitudinal axis from a first position proximate the first end to a second position proximate the second end; and
a turning film disposed adjacent the light output region, the turning film having a turning surface comprising tapered protrusions, each having a vertex adjacent the interior of the hollow light duct,
wherein light rays propagating through the hollow light duct that intersect the light transmissive region, exit the hollow light duct and are redirected by the turning film to a direction substantially normal to the longitudinal axis.

2. The lighting element of claim 1, wherein the interior surface comprises a light reflective surface selected from a metal, a metal alloy, a dielectric film stack, or a combination thereof.

3. The lighting element of claim 1, further comprising a first light source positioned proximate the first end capable of injecting a first light into the hollow light duct.

4. The lighting element of claim 1, wherein the second end comprises a reflector, and the output angle increases from the first position to the second position.

5. The lighting element of claim 1, wherein the output angle increases in a range from about 0 degrees at the first position to about 90 degrees at the second position.

6. The lighting element of claim 1, further comprising a second light source positioned proximate the second end capable of injecting a second light into the hollow light duct, and wherein the output angle increases from the first position to a midpoint position and decreases from the midpoint position to the second position.

7. The lighting element of claim 6, wherein the output angle increases in a range from about 0 degrees at the first position to about 90 degrees at the midpoint position, and then decreases in a range from about 90 degrees at the midpoint position to about 0 degrees at the second position.

8. The lighting element of claim 1, further comprising a light transport region between the first end and the first position, between the second end and the second position, or between both.

9-12. (canceled)

13. The lighting element of claim 1, wherein each of the tapered protrusions are adjacent an exterior surface of the hollow light duct.

14. (canceled)

15. The lighting element of claim 1, wherein light rays propagate in a light duct propagation direction within a first collimation half-angle of the longitudinal axis, and exit in an exit propagation direction that is different than the light duct propagation direction, the exit propagation direction having a second collimation half-angle.

16. The lighting element of claim 15, wherein the second collimation half-angle is greater than the first collimation half-angle.

17. The lighting element of claim 1, wherein the curved cross-section comprises a circle, an oval, an ellipse, an arc, or a combination thereof.

18. The lighting element of claim 1, wherein the hollow light duct is sealed from an ambient environment.

19. The lighting element of claim 1, wherein the tapered protrusions comprise conical shaped microstructures.

20. The lighting element of claim 19, wherein the conical shaped microstructures have a hexagonal base cross-section, a circular cross-section proximate the vertex, and a transitional cross-section therebetween.

21. The lighting element of claim 19, wherein the conical shaped microstructures have a vertex included angle of about 67 degrees.

22-30. (canceled)
